(19) United States
(12) Patent Application Publication
(10) Pub. No.: US 2025/0182460 A1
(43) Pub. Date: Jun. 5, 2025

(54) REFINING IMAGE FEATURES AND/OR DESCRIPTORS

(71) Applicant: QUALCOMM Incorporated, San Diego, CA (US)

(72) Inventors: Shivansh RAO, San Diego, CA (US); Nirmal ELAMON, San Diego, CA (US); Saurav GUPTA, Bangalore (IN); Arunkumar NEHRUR RAVI, San Diego, CA (US); Vasudev BHASKARAN, San Diego, CA (US)

(21) Appl. No.: 18/529,389

(22) Filed: Dec. 5, 2023

(51) Int. Cl. G06V 10/80; G06T 7/20; G06T 7/70; G06V 10/46

(52) U.S. Cl. CPC G06V 10/806; G06T 7/20; G06T 7/70; G06V 10/467

(57) ABSTRACT

Systems and techniques are described herein for refining image keypoints. For instance, a method for refining image keypoints is provided. The method may include encoding keypoints to generate keypoint embeddings, wherein each keypoint of the keypoints comprises a respective image coordinate; encoding descriptors to generate descriptor embeddings, wherein each descriptor of the descriptors comprises a respective vector of values based on pixels within a threshold distance from a respective image coordinate of a respective keypoint corresponding to the descriptor; combining the keypoint embeddings and the descriptor embeddings to generate feature embeddings; refining the keypoints based on the feature embeddings; and refining the descriptors based on the feature embeddings.

### TECHNICAL FIELD

The present disclosure generally relates to processing image data. For example, aspects of the present disclosure include systems and techniques for refining image keypoints and/or descriptors of the keypoints.

### BACKGROUND

Many computer-vision tasks (e.g., 6-degree-of-freedom (6DoF) position determination, three dimensional (3D)-reconstruction, localization, global-flow estimation, etc.) rely on image keypoints and corresponding descriptors. For example, 6DoF pose determination may involve capturing images of a scene using a camera and determine a change in a pose of a camera based on the captured images. Determining the change in the pose may rely on comparing keypoints between images (e.g., comparing keypoints of a first image with keypoints of a second image). Other computer-vision tasks may similarly use keypoints of images.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for refining image keypoints. According to at least one example, a method is provided for refining image keypoints. The method includes: encoding keypoints to generate keypoint embeddings, wherein each keypoint of the keypoints comprises a respective image coordinate; encoding descriptors to generate descriptor embeddings, wherein each descriptor of the descriptors comprises a respective vector of values based on pixels within a threshold distance from a respective image coordinate of a respective keypoint corresponding to the descriptor; combining the keypoint embeddings and the descriptor embeddings to generate feature embeddings; refining the keypoints based on the feature embeddings; and refining the descriptors based on the feature embeddings.

In another example, an apparatus for refining image keypoints is provided that includes at least one memory and at least one processor (e.g., configured in circuitry) coupled to the at least one memory. The at least one processor configured to: encode keypoints to generate keypoint embeddings, wherein each keypoint of the keypoints comprises a respective image coordinate; encode descriptors to generate descriptor embeddings, wherein each descriptor of the descriptors comprises a respective vector of values based on pixels within a threshold distance from a respective image coordinate of a respective keypoint corresponding to the descriptor; combine the keypoint embeddings and the descriptor embeddings to generate feature embeddings; refine the keypoints based on the feature embeddings; and refine the descriptors based on the feature embeddings.

In another example, a non-transitory computer-readable medium is provided that has stored thereon instructions that, when executed by one or more processors, cause the one or more processors to: encode keypoints to generate keypoint embeddings, wherein each keypoint of the keypoints comprises a respective image coordinate; encode descriptors to generate descriptor embeddings, wherein each descriptor of the descriptors comprises a respective vector of values based on pixels within a threshold distance from a respective image coordinate of a respective keypoint corresponding to the descriptor; combine the keypoint embeddings and the descriptor embeddings to generate feature embeddings; refine the keypoints based on the feature embeddings; and refine the descriptors based on the feature embeddings.

In another example, an apparatus for refining image keypoints is provided. The apparatus includes: means for encoding keypoints to generate keypoint embeddings, wherein each keypoint of the keypoints comprises a respective image coordinate; means for encoding descriptors to generate descriptor embeddings, wherein each descriptor of the descriptors comprises a respective vector of values based on pixels within a threshold distance from a respective image coordinate of a respective keypoint corresponding to the descriptor; means for combining the keypoint embeddings and the descriptor embeddings to generate feature embeddings; means for refining the keypoints based on the feature embeddings; and means for refining the descriptors based on the feature embeddings.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of an image including a keypoint according to various aspects of the present disclosure;

FIG. 2 is a diagram illustrating an example of relative pose determination using points of interest from images captured at different cameras according to various aspects of the present disclosure;

FIG. 3 is a block diagram illustrating an example system that may refine keypoints and/or descriptors, according to various aspects of the present disclosure;

FIG. 4 is a block diagram illustrating an example system that may include feature refinement network to refine keypoints and/or descriptors, according to various aspects of the present disclosure;

FIG. 5 is a block diagram illustrating an example system that may include feature refinement network to refine keypoints and/or descriptors, according to various aspects of the present disclosure;

FIG. 6 is a block diagram illustrating an example system that may include feature refinement network to refine keypoints and/or descriptors, according to various aspects of the present disclosure;

FIG. 7 is a block diagram of an example system that may generate keypoints and descriptors, according to various aspects of the present disclosure;

FIG. 8 is a block diagram of an example system that may generate refined keypoints and/or refined descriptors based on keypoints and descriptors, according to various aspects of the present disclosure;

FIG. 9 is a block diagram of an example system that may generate refined keypoints and/or refined descriptors based on keypoints and descriptors, according to various aspects of the present disclosure;

FIG. 10 is a block diagram of an example transformer that may be used to apply an attention function to feature embeddings to refine keypoints and/or descriptors, according to various aspects of the present disclosure;

FIG. 11 is a flow diagram illustrating another example process for refining keypoints and/or descriptors, in accordance with aspects of the present disclosure;

FIG. 12 is a block diagram illustrating an example of a deep learning neural network that can be used to perform various tasks, according to some aspects of the disclosed technology;

FIG. 13 is a block diagram illustrating an example of a convolutional neural network (CNN), according to various aspects of the present disclosure; and

FIG. 14 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As previously noted, many computer-vision tasks may rely on keypoints determined from images. There are various techniques for generating keypoints, such as scale-invariant feature transform (SIFT), speeded-up robust features (SURF), features from accelerated segment test (FAST), binary robust independent elementary feature (BRIEF), and oriented FAST and rotated BRIEF (ORB). Many of such techniques are relatively computationally intensive (e.g., requiring many computing operations which may take time and/or consume power). Further, many of such techniques are so computationally intensive that they are not well suited to real-time operation. Further, many of such techniques perform relatively poorly on images captured in low-light conditions, on images captured in harsh weather conditions, and/or on pairs of images captured from viewing angles that are far apart.

Systems, apparatuses, methods (also referred to as processes), and computer-readable media (collectively referred to herein as “systems and techniques”) are described herein for refining keypoints and/or descriptors of keypoints. The systems and techniques described herein may determine or obtain keypoints from images and descriptors of the keypoints, and may refine the keypoints and/or the descriptors based on the keypoints and the descriptors. By refining the keypoints and the descriptors, the systems and techniques may cause the refined keypoints and/or the refined descriptors to be more robust and/or more accurate.

In some cases, the systems and techniques may generate keypoints that are more robust to viewpoint translations. For example, a first image of a scene may be captured from a first viewpoint. First keypoints may be determined within the first image and first descriptors of the first keypoints may be determined. A second image of the scene may be captured from a second viewpoint. A system may attempt to find the first keypoints within the second image (e.g., by comparing the descriptors of the first keypoints to pixels of the second image). If the difference between the first viewpoint and the second viewpoint is relatively large, the system may not be able to find the first keypoints in the second image. However, the systems and techniques may refine the first keypoints to cause the first keypoints to be more robust and thus casier to find in the second image.

Further, the systems and techniques may increase a resolution of the keypoints. For example, the keypoints may be derived from an image and may be, or may include, image coordinates of the keypoints in the image. Initially, the keypoints may have a pixel-level resolution (corresponding to the image pixels). For example, a keypoint may be (3, 4), for example, three pixels in an×direction and 4 pixels in a y direction. After refinement, the refined keypoints may have a sub-pixel resolution. For example, a refined keypoint may be (2.9, 4.3). The systems and techniques may refine the keypoint locations {x, y} as well as the descriptor values which may result in improvements to feature-extractor metrics in terms of repeatability, matching score, mean-matching accuracy and mean homography accuracy.

The systems and techniques may refine the keypoints and/or the descriptors without using the image from which the keypoints and descriptors were taken. By not using the image, the systems and techniques may perform relatively quickly and without requiring passing the image through data pipelines. For example, because the systems and techniques operate on keypoints and descriptors, and not on the images on which the keypoints are based, feature encoders of the systems and techniques do not require high receptive field convolution layers. For example, encoders of the systems and techniques do not require a layer having as many elements as there are pixels in the image. Since the systems and techniques directly run on the keypoints and descriptor values (e.g., and not images), the systems and techniques may be is independent of the input images and may thus save compute time. The systems and techniques do not have to process the full image resolutions (e.g., height*width, “H*W”), thus, saving time on the data flow interface.

Further, the systems and techniques may be, or may include, a modular feature refinement network. For example, the systems and techniques may be implemented by a feature refinement network that may be used as part of computer-vision pipelines. For example, the feature refinement network may be added to an existing pipeline implementing 6-degree-of-freedom (6DoF) position determination, three dimensional (3D)-reconstruction, localization, and/or global-flow estimation. In some aspects, the systems and techniques may be treated as a standalone block just for refinement which can be used after any feature extractor to boost the performance of any feature extractor (be it handcrafted features or deep-learning based features) and thus acts like an individual module.

Various aspects of the application will be described with respect to the figures below.

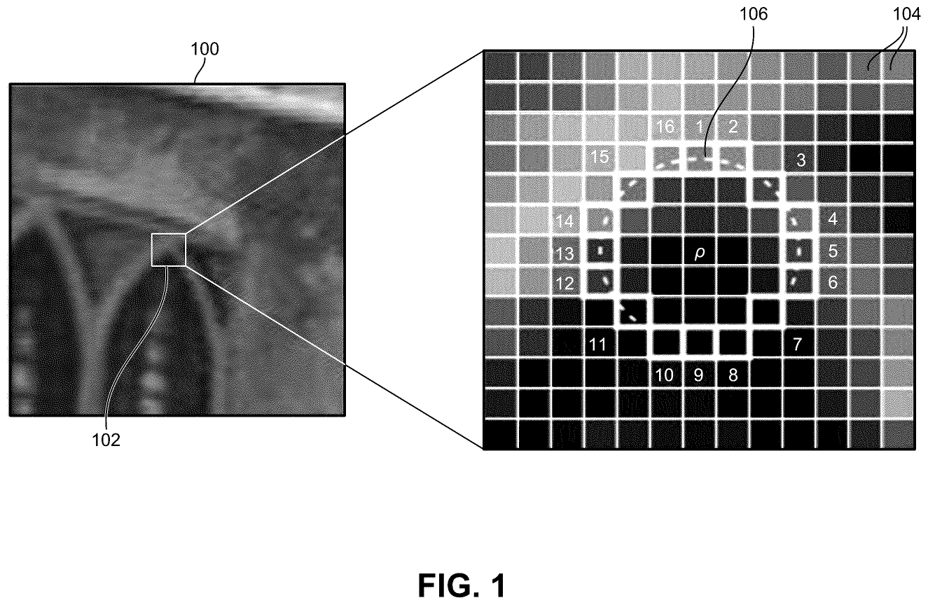

FIG. 1 is a diagram illustrating an example of an image 100 including a keypoint p according to various aspects of the present disclosure. Keypoint p is surrounded by a window 102 of pixels 104 in the image 100. Keypoint p may be selected such that keypoint p can be matched between images. For example, Keypoint p may be visually distinct in image 100. Keypoint p may be, as an example, a corner point on an object. In the art a keypoint may be alternatively referred to as a visual feature, a point of interest or a key point. An example keypoint-detection method is described with regard to FIG. 1. In particular, FIG. 1 illustrates the Features from Accelerated Segment Test (FAST) technique (Machine Learning for High-Speed Corner Detection, Edward Rosten & Tom Drummond, ECCV 2006: Computer Vision-ECCV 2006 pp 430-443, Part of the Lecture Notes in Computer Science book series (LNIP, volume 3951)). In the FAST method, a pixel under test (e.g., pixel p) with intensity Ip may be identified as an interest point. A circle 106 of sixteen pixels (pixels 1-16) around the pixel under test p (e.g., a Bresenham circle of radius 3) may then be identified. The pixel under test p may be considered a keypoint if there exists a set of n contiguous pixels in circle 106 of sixteen pixels that are all brighter than Ip+t, or all darker than Ip-1, where t is a threshold value and n is configurable. In this example, n may be twelve. For example, the intensity of pixels 1, 5, 9, and 13 of the circle may be compared with Ip. If at least three of the four pixels do not satisfy the threshold criteria, the pixel p is not considered an interest point. As can be seen in FIG. 1, at least three of the four pixels satisfy the threshold criteria. Therefore, all sixteen pixels may be compared to pixel p to determine if twelve contiguous pixels meet the threshold criteria. This process may be repeated for each of pixels 104 in the image 100 to identify the corner points corresponding to keypoint p in image 100.

Although FIG. 1 illustrates a FAST keypoint-identifying method, it should be understood that the present disclosure is applicable to any keypoint-identifying method. Examples of keypoint-identifying methods may include, but are not limited to, speeded-up robust features (SURF), scale-invariant feature transform (SIFT), binary robust independent elementary feature (BRIEF), oriented FAST and rotated BRIEF (ORB), and Harris corner point.

As indicated above, a keypoint p represents a feature of an image 100 that may be matched between multiple images of a scene (e.g., captured from different viewing angles and/or with different intrinsic camera parameters). For example, various cross-correlation or optical flow methods may match features (keypoints) across multiple images. In some examples, each feature may further include a feature descriptor that assists with the matching process. A feature descriptor may summarize, in vector format (e.g., of constant length) one or more characteristics of pixels 104 of window 102. For example, the feature descriptor may correspond to the intensity of pixels 104 of window 102. As another example, the feature descriptor may correspond to pixels within a threshold distance of keypoint p. For instance, the feature descriptor may correspond to all pixels within 6 pixels above, to the right of, below, and/or to the right of pixel p. In general, feature descriptors are independent of the positions of keypoint p, robust against image transformations, and scale independently. Thus, keypoints with feature descriptors may be independently re-detected in each image frame and then subjected to a keypoint matching/tracking procedure. For example, the keypoints in two different images with matching descriptors and the smallest distance between them may be considered to be matching keypoints. Examples of feature-descriptor methods may include, but are not limited to, ORB, SURF, and BRIEF.

A relative pose of two cameras (or of one camera at two times) may be calculated based on the two-dimensional displacement of a plurality of keypoints in images from each of the cameras (or in images captured by the one camera at the two times). For example, the pose may be determined by forming and factoring an essential matrix using eight keypoints or using Nister's method with five keypoints. As another example, a Perspective-n-Point (PnP) algorithm with three keypoints may be used to determine the pose if keypoint depth is also being tracked. In some aspects, images captured by different cameras (e.g., of different devices or vehicles) that contain a minimum number of the same features (e.g., based on the pose determination method) may be used to determine the relative pose between the cameras.

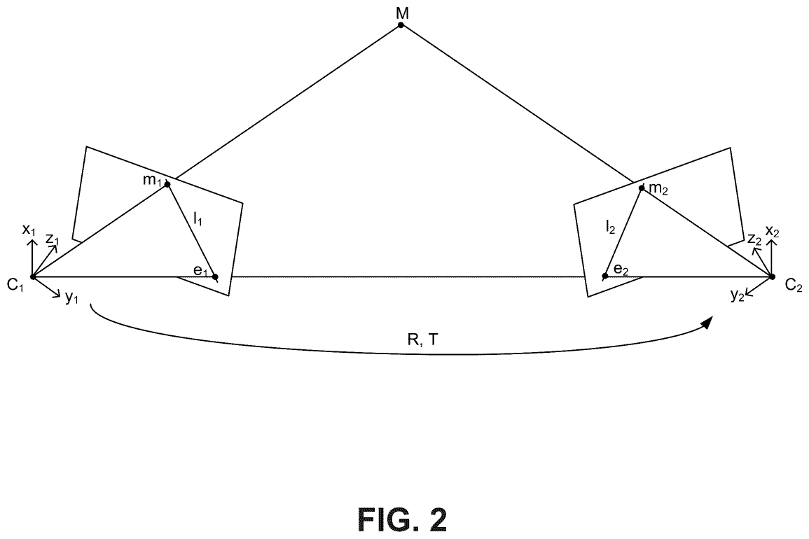

FIG. 2 is a diagram illustrating an example of relative pose determination using keypoints from images captured at different cameras C1 and C2 according to various aspects of the present disclosure. In the example shown in FIG. 2, each of the cameras C1 and C2 may be positioned on a different device, such as an extended reality (XR) device, a mobile device, a vehicle, or a roadside unit. A real point M in three-dimensional space (x, y, z) may be projected onto the respective image planes I1 and I2 of each of the vehicle cameras C1 and C2 to produce features (keypoints) m1 and m2. By correlating or associating (e.g., matching) multiple sets of features (e.g., corresponding to multiple real points), the epipolar constraint (e.g., line 11 between m1 and e1 and line 12 between m2 and e2) on the relative vehicle pose may be extracted. As a result, based on the keypoints of multiple real points and the epipolar constraint, a first device associated with camera C1 may determine the relative pose (Rotation (R), Translation (T)) of the first device with respect to a second device associated with camera C2. If the location of one camera C1 or camera C2 (in a global coordinate system) is known, the relative pose may be used to determine the location of the other of the cameras (in the global coordinate system).

The same principles apply to determining a change in a pose of a single camera between a first time and a second time. For example, at a first time the camera may be at the position of C1 and may capture 11. At a second time, the camera may be at the position of C2 and may capture 12. A device including the camera may determine the change in pose between the first time and the second time as described above.

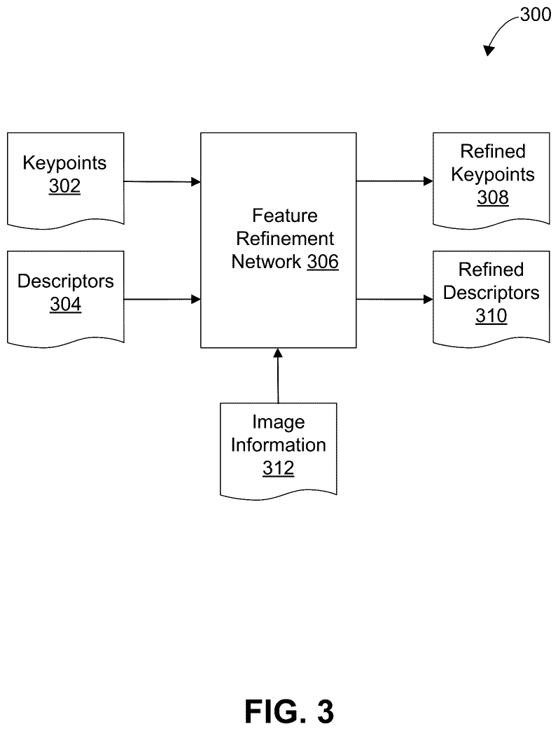

FIG. 3 is a block diagram illustrating an example system 300 that may refine keypoints 302 and/or descriptors 304, according to various aspects of the present disclosure. For example, system 300 includes feature refinement network 306. Feature refinement network 306 may obtain keypoints 302 and descriptors 304, refine keypoints 302 to generate refined keypoints 308, and/or refine descriptors 304 to generate refined descriptors 310.

Keypoints 302 may be, or may include, image coordinates of keypoints of an image. For example, keypoint p of FIG. 1 may be an example of one of keypoints 302.

Descriptors 304 may be, or may include, vectors of values describing keypoints 302. Descriptors 304 may include a vector of values corresponding to each one of keypoints 302. Using keypoint p of FIG. 1 as an example one of keypoints 302, descriptors 304 may include a vector of values based on pixels 104 of window 102. The vectors of values may include any number of values for each keypoint of keypoints 302.

Feature refinement network 306 may be, or may include, one or more machine-learning models trained to refine keypoints and/or descriptors. For example, feature refinement network 306 may be trained through an iterative backpropagation process.

For example, a corpus of training data may be obtained. The corpus of training data my include sets of keypoints, descriptors, refined keypoints, and refined descriptors. During the training procedure, feature refinement network 306 may be provided with keypoints and corresponding descriptors derived from an image. Feature refinement network 306 may adjust the keypoints and the descriptors. The adjusted keypoints and descriptors may be compared with refined keypoints and refined descriptors of the training data. A loss (or “error”) may be determined based on differences between the keypoints and descriptors adjusted by feature refinement network 306 and the refined keypoints and refined descriptors of the training data. Additionally or alternatively, the loss may be determined based on successes in matching the adjusted keypoints with keypoints of the training data based on the descriptors. Parameters (e.g., weights) of feature refinement network 306 may be adjusted based on the loss to decrease the loss in future iterations of the iterative training process, for example, according to a gradient descent loss-minimization technique.

In some aspects, feature refinement network 306 may be trained in an end-to-end training process with a consumer of refined keypoints and/or refined descriptors. For example, the corpus of training data may be, or may include, sets of keypoints, descriptors, and outputs of the consumer. For instance, the consumer may be a 6DoF-pose determiner that may output pose information. The training data may include sets of keypoints, descriptors, and pose information. During the training procedure, the keypoints and descriptors may be provided to feature refinement network 306. Feature refinement network 306 may adjust the keypoints and descriptors and provided the adjusted keypoints and descriptors to the consumer. The consumer may generate outputs based on the adjusted keypoints and descriptors. The outputs may be compared with outputs of the training data and a loss may be determined based on a difference between the outputs and the outputs of the training data. Parameters (e.g., weights) of feature refinement network 306 (and/or of the consumer) may be adjusted based on the loss to decrease the loss in future iterations of the iterative training process, for example, according to a gradient descent loss-minimization technique.

Refined keypoints 308 may be, or may include, image coordinates of the keypoints of the image. Refined keypoints 308 may be based on keypoints 302 and may include one refined keypoint corresponding to each one of keypoints 302. Refined keypoints 308 may have a sub-pixel resolution. For example, whereas keypoints 302 may be image coordinates with a pixel-level resolution, refined keypoints 308 may have a sub-pixel resolution. For example, keypoints 302 may include a keypoint (3, 4) which may indicate a pixel that is at 3 pixels in an×direction and 4 pixels in a y direction. Refined keypoints 308 may include a refined keypoint (2.9, 4.3) which indicates a point in the image that has a sub-pixel resolution.

Refined descriptors 310 may be, or may include, vectors of values describing refined keypoints 308. Refined descriptors 310 may include a vector of values corresponding to each one of refined keypoints 308. Refined descriptors 310 may be robust. For example, refined descriptors 310 may be used by a consumer to match with keypoints from an image captured from a different viewing angle. Additionally or alternatively, refined descriptors 310 may be used to match despite refined descriptors 310 being based on an image captured in harsh weather conditions (e.g., rain, snow, or fog).

In order to generate robust of descriptors, feature refinement network 306 may be trained using sets of images captured from various viewing angles, sets of images adjusted according to various transformations (e.g., a homography), and/or sets of images captured under different weather conditions (or simulated as if the images were captured under different weather conditions). For example, in several iterations of a training process, keypoints and descriptors based on a baseline image may be provided to feature refinement network 306 and feature refinement network 306 may generate adjusted keypoints and descriptors. The keypoints and descriptors based on the baseline image may include various keypoints and descriptors based on one or more of: a rotated version of the baseline image, a translated version of the baseline image, a skewed version of the baseline image, a version of the baseline image with added noise, and/or a version of the baseline image under simulated weather conditions. Losses may be determined based on how well the adjusted keypoints generated by feature refinement network 306 are matched to keypoints of the training data. For example, feature refinement network 306 may be provided with keypoints and descriptors based on a transformed version of a baseline image. Feature refinement network 306 may generate adjusted keypoints and descriptors based on the transformed version of the baseline image. The adjusted keypoints may be matched with keypoints based on the baseline image. A loss may be determined based on how well the adjusted keypoints are matched with the keypoints based on the baseline image. Feature refinement network 306 may be adjusted based on the loss.

In some aspects, feature refinement network 306 may generate refined keypoints 308 and refined descriptors 310 based on keypoints 302 and descriptors 304. In some aspects, feature refinement network 306 may generate refined keypoints 308 and refined descriptors 310 based on keypoints 302, descriptors 304, and image information 312. Image information 312 may include information related to pixels on which refined descriptors 310 may be generated. For example, image information 312 may include values of pixels proximate to keypoints 302. Using keypoint p of FIG. 1 as an example, image information 312 may include values of one or more of pixels 104 of window 102. In some aspects, keypoints 302 and/or descriptors 304 may include values of pixels proximate to keypoints, for example, as metadata.

Feature refinement network 306 may be included as a module in another system. For example, feature refinement network 306 may be included in a computer-vision system and may be used to refine keypoints and descriptors.

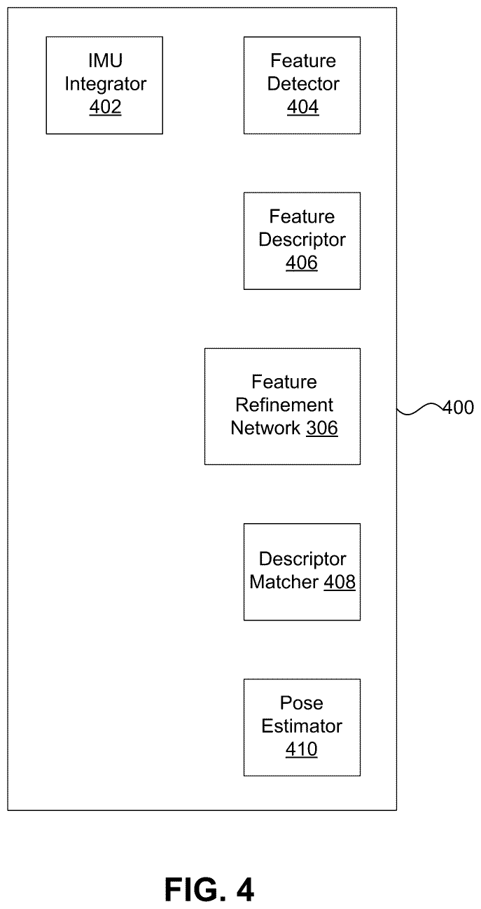

For example, FIG. 4 is a block diagram illustrating an example system 400 that may include feature refinement network 306 to refine keypoints and/or descriptors, according to various aspects of the present disclosure. For instance, system 400 may be a pose estimator included in a display (e.g., a head-mounted display (HMD)) of an extended reality (XR) system. System 400 may receive motion data from one or more inertial measurement units (IMUs) and an IMU integrator 402 that may collect and integrate motion data from the IMUs. System 400 may also receive image data from one or more cameras that may capture images. Feature detector 404 of system 400 may generate features (e.g., keypoints) based on the images and feature descriptor 406 may generate descriptors of the features. Feature refinement network 306 may be a module implemented in system 400 to refine the keypoints and/or descriptors. Feature refinement network 306 may generate refined keypoints and/or refined descriptors. Descriptor matcher 408 of system 400 may match refined keypoints between images (based on the refined descriptors) and pose estimator 410 may determine a pose of the cameras which captured the images (and/or of a device that includes the cameras) based on the keypoints matched between the images and/or based on motion data from IMU integrator 402.

Because feature refinement network 306 may refine the keypoints and/or the descriptors (e.g., generating robust descriptors), descriptor matcher 408 may be enabled to better match keypoints between images that are captured from different viewing angles. Thus, feature refinement network 306 may improve the overall operation of system 400.

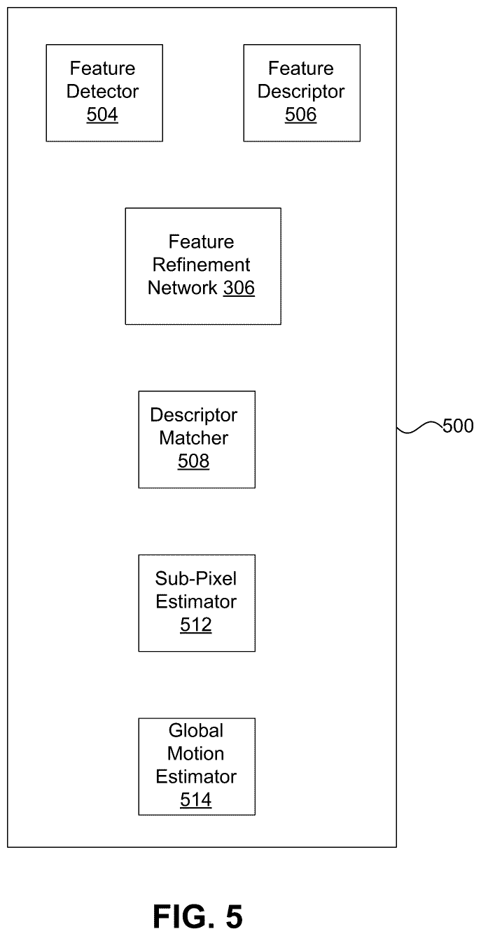

As another example, FIG. 5 is a block diagram illustrating an example system 500 that may include feature refinement network 306 to refine keypoints and/or descriptors, according to various aspects of the present disclosure. For instance, system 500 may implement a global flow estimation pipeline. System 500 may receive image data from one or more cameras. Feature detector 504 of system 500 may generate features (e.g., keypoints) based on the images and feature descriptor 506 may generate descriptors of the keypoints. Feature refinement network 306 may be a module implemented in system 500 to refine the keypoints and/or descriptors. Feature refinement network 306 may generate refined keypoints and/or refined descriptors. Descriptor matcher 508 of system 500 may match refined keypoints between images (based on the refined descriptors). Sub-pixel estimator 512 may estimate the position of the keypoints at a sub-pixel resolution. Global motion estimator 514 may determine motion of the camera which captured the images (and/or of a device that includes the cameras) based on the relative positions of the matching keypoints between the images.

Feature refinement network 306 may refine the keypoints to generate sub-pixel-resolution image coordinates. Because feature refinement network 306 may generate sub-pixel-resolution image coordinates, in some aspects, system 500 may omit sub-pixel estimator 512. In other aspects, feature refinement network 306 may simplify the task of sub-pixel estimator 512 which may conserve computational resources (such as time and/or power).

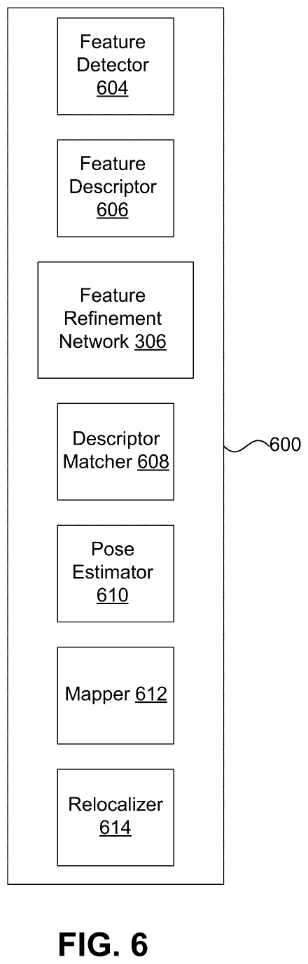

As yet another example, FIG. 6 is a block diagram illustrating an example system 600 that may include feature refinement network 306 to refine keypoints and/or descriptors, according to various aspects of the present disclosure. For instance, system 600 may implement a localization pipeline (e.g., in a vehicle). System 600 may receive image data from one or more cameras. Feature detector 604 of system 600 may generate features (e.g., keypoints) based on the images and feature descriptor 606 may generate descriptors of the keypoints. Feature refinement network 306 may be a module implemented in system 600 to refine the keypoints and/or descriptors. Feature refinement network 306 may generate refined keypoints and/or refined descriptors. Descriptor matcher 608 of system 600 may match refined keypoints between images (based on the refined descriptors). Pose estimator 610 may estimate a pose of the cameras which captured the images (and/or of a device that includes the cameras) based on the relative positions of the matching keypoints in the images. Mapper 612 may relate the pose of the cameras to map information (and/or to location information, for example, determined by a location system). Relocalizer 614 may determine a location of the cameras based on map information from mapper 612 and/or based on pose information from pose estimator 610.

Feature refinement network 306 may refine the keypoints to generate more accurate keypoints and/or more robust descriptors. The accurate keypoints and/or the robust descriptors may improve the overall performance of system 600.

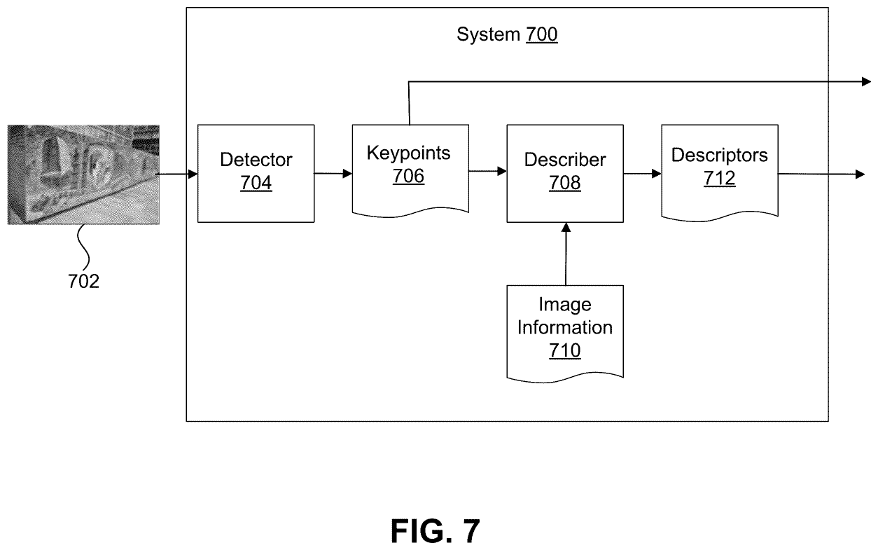

FIG. 7 is a block diagram of an example system 700 that may generate keypoints 706 and descriptors 712, according to various aspects of the present disclosure. System 700 may obtain an image 702. Detector 704 of system 700 may generate keypoints 706 based on image 702. Detector 704 may be, or may include, a machine-learning model (e.g., a neural network) trained to generate keypoints based on images. Detector 704 may implement FAST, SIFT, SURF, BRIEF, ORB, etc. to generate keypoints 706. Keypoints 706 may be, or may include, image coordinates of keypoints in image 702. Keypoints 706 may be an example of keypoints 302 of FIG. 3.

Describer 708 of system 700 may generate descriptors 712 based on keypoints 706 and image information 710. Describer 708 may be, or may include, a machine-learning model (e.g., a neural network) trained to generate descriptors based on keypoints and image information. Describer 708 may implement FAST, SIFT, SURF, BRIEF, ORB, etc. to generate descriptors 712. Descriptors 712 may be, or may include, vectors of values describing respective ones of keypoints 706. For example, descriptors 712 may include values based on pixels in windows around keypoints 706. Image information 710 may include image information (e.g., values of pixels) based on keypoints 706. For example, image information 710 may include values of pixels in windows proximate to each of keypoints 706. Describer 708 may generate descriptors 712 based on image information 710. Descriptors 712 may be an example of descriptors 304 of FIG. 3.

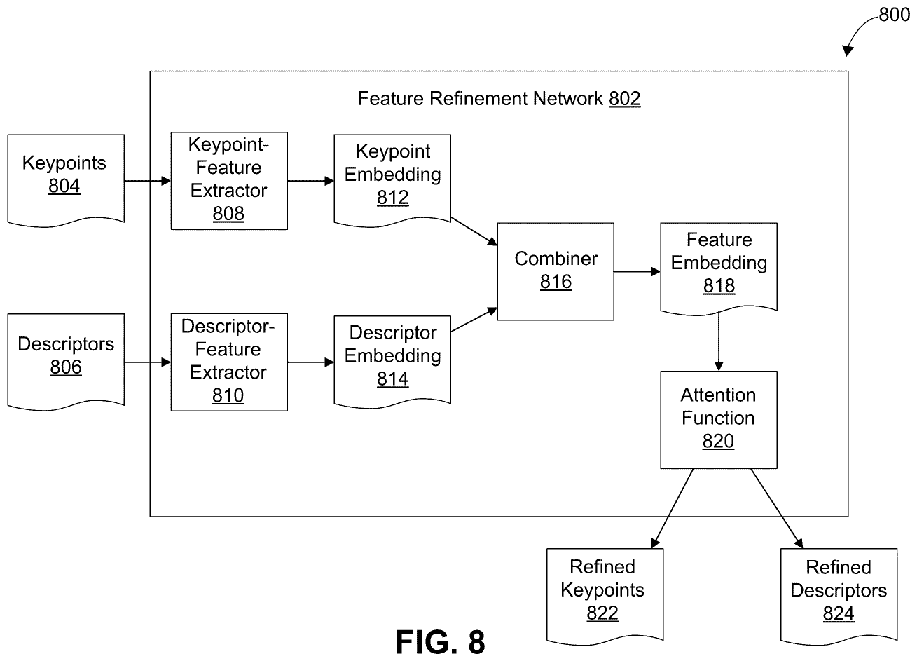

FIG. 8 is a block diagram of an example system 800 that may generate refined keypoints 822 and/or refined descriptors 824 based on keypoints 804 and descriptors 806, according to various aspects of the present disclosure. In general, system 800 may obtain keypoints 804 and descriptors 806, encode keypoints 804 to generate keypoint embedding 812, encode descriptors 806 to generate descriptor embedding 814, combine keypoint embedding 812 and descriptor embedding 814 to generate feature embedding 818, and apply attention function 820 to correlate feature embeddings of feature embedding 818 with other feature embeddings of feature embedding 818 to generate refined keypoints 822 and/or refined descriptors 824.

System 800 includes feature refinement network 802, which may be, or may include, one or more machine-learning models trained to refine keypoints and/or descriptors. Feature refinement network 802 may include keypoint-feature extractor 808, descriptor-feature extractor 810, combiner 816, and attention function 820. Feature refinement network 802 may be an example of feature refinement network 306 of FIG. 3.

Keypoints 804 may be, or may include, image coordinates representative of keypoints of an image. Keypoints 804 may be an example of keypoints 302 of FIG. 3 and/or of keypoints 706 of FIG. 7. Keypoints 804 may include n*2 values (e.g., an×coordinate and a y coordinate for each of n keypoints).

Descriptors 806 may be, or may include, vectors of values descriptive of keypoints 804. For example, descriptors 806 may include one vector of values corresponding to each keypoint of keypoints 804. Descriptors 806 may be an example of descriptors 304 of FIG. 3 and/or of descriptors 712 of FIG. 7. Descriptors 806 may include n*p values (e.g., a vector of p values for each of the n keypoints of keypoints 804).

Keypoint-feature extractor 808 may generate keypoint embedding 812 based on keypoints 804. For example, keypoint-feature extractor 808 may generate embeddings, which may be, or may include, a matrix of values that is an implicit representation of keypoints 804 according to the training of keypoint-feature extractor 808. Keypoint-feature extractor 808 may be, or may include, for example, a multi-layer perceptron (MLP). For example, keypoint-feature extractor 808 may include an MLP of three linear layers with a batch-normalization layer and a rectified linear unit (ReLU) activation for each layer. Keypoint-feature extractor 808 may generate keypoint embedding 812 with n*p values.

Descriptor-feature extractor 810 may generate descriptor embedding 814 based on descriptors 806. For example, descriptor-feature extractor 810 may generate embeddings, which may be, or may include, a matrix of values that is an implicit representation of descriptors 806 according to the training of descriptor-feature extractor 810. Descriptor-feature extractor 810 may be, may be, or may include, for example, an MLP. For example, descriptor-feature extractor 810 may include an MLP of three linear layers with a batch-normalization layer and a ReLU activation for each layer. Descriptor-feature extractor 810 may generate descriptor embedding 814 with n*p values.

Combiner 816 may combine keypoint embedding 812 and descriptor embedding 814 to generate feature embedding 818. In some aspects, combiner 816 may concatenate keypoint embedding 812 and descriptor embedding 814 to generate feature embedding 818. In some aspects, combiner 816 may apply an attention function (e.g., a weighted attention function) to correlate keypoint embedding 812 and descriptor embedding 814 to generate feature embedding 818. Combiner 816 may apply self attention to keypoint embedding 812 and descriptor embedding 814 (e.g., determining a relevance of each of keypoint embedding 812 and descriptor embedding 814 relative to itself). Combiner 816 may use attention to fuse keypoint embedding 812 and descriptor embedding 814 because the efficacy of given keypoints and descriptors may not be the same. For example, in many cases one or both of the keypoints or the descriptors may not be robust. Using attention, combiner 816 may cause feature refinement network 802 to pay attention to both keypoints and descriptors individually before fusing keypoint embedding 812 and descriptor embedding 814 into feature embedding 818.

Combiner 816 may generate a weight matrix Wᵢ including a weight value (indicating an importance) for each of keypoint embeddings 812 and each of descriptor embeddings 814. The weights may be determined by applying a linear mapping followed by a tanh activation:

$${a}_{i} = tanh ( Ω * {X}_{i} )$$

where Xᵢ represents respective values of each of keypoint embeddings 812 and each of descriptor embeddings 814;
where aᵢ is attention; and
where Ω is the vector of parameters for the linear mapping.

A fused embedding:

$$Fe = Σ {X}_{i} * {a}_{i}$$

may give the fused feature after applying the weights to each of keypoint embeddings 812 and descriptor embeddings 814. The process may be repeated for each of keypoint embedding 812 and descriptor embedding 814 and may result in feature embedding 818.

The output of feature extractor network (e.g., feature embedding 818) helps capture the self-embeddings of each keypoint and descriptor independent of other features. Hence, we denote this stage (e.g., the combination of keypoint embedding 812 and descriptor embedding 814 at combiner 816) as self attention. Combiner 816 may generate feature embedding 818 with n*p values.

Attention function 820 may apply cross attention, for example, to determine a relevance of each feature embedding of feature embedding 818 to each of the other feature embeddings. For example, attention function 820 may correlate each feature embedding of feature embedding 818 to each of the other feature embeddings of feature embedding 818.

Attention function 820 may generate refined keypoints 822 and refined descriptors 824. Refined keypoints 822 may have n*2 values (e.g., an×coordinate and a y coordinate for each of keypoints). Refined keypoints 822 may have a sub-pixel resolution. Refined descriptors 824 may have n*p values.

Feature refinement network 802 may be trained with two sets of losses, for example, one for generating refined keypoints 822 and another for generating refined descriptors 824. The losses may be referred to as descriptor loss and keypoint loss.

The descriptor loss may be related to maximizing the Average Precision (AP) by training feature refinement network 802 to minimize for (1-AP) for each descriptor (d′77). This learning will directly use the ground truth homography during the precision calculation and force the model to generate descriptor values that are closer to the ground truth descriptor values. N stands for the total number of keypoints and d^{fm} stands for feature refinement network's (FRN's) predicted descriptors.

$${L}^{AP} = 1 - \frac{1}{N ( {\sum }_{i = 1}^{N} AP ( {d}_{i}^{frn} ) )}$$

However, while minimizing for the above loss, it also needs to be ensured that the predicted descriptors (FRN) are better than the original descriptors (e.g., that refined descriptors 824 are better than descriptors 806). To enforce this, another loss term (which may be referred to as refinement loss) is used. Refinement loss may make use of the original descriptor (e.g., descriptors 806). This will enforce the predicted descriptor (d^{fm}) to be better than the original descriptor (dx). N stands for the total number of keypoints, d^{fm} stands for refined descriptors 824 and dx stands for descriptors 806.

$${L}^{refinement \_ descriptor} = \frac{1}{N ( {\sum }_{i = 1}^{N} max ( 0 , ( \frac{AP ( {d}^{x} )}{AP ( {d}^{frn} )} ) - 1 )}$$

In this way the final descriptor loss is as follows, where Φ¹ is a learnable parameter which acts as a regularization term:

$${L}^{descriptor} = {L}^{AP} + {Φ}^{1} {L}^{refinement \_ descriptor}$$

The keypoint loss may include regressing for the L2 norm between the predicted keypoints and its corresponding locations on the paired image (using ground truth homography). For example, refined keypoints 822 may be compared with the ground truth keypoints. If the ith predicted keypoint of refined keypoints 822 on the input image is {x_{fm}, y_{fm}}(i) and its corresponding keypoint of refined keypoints 822 on the paired image is {X_{fr_paired}, Y_{fm_paired}}(1), then the ground truth homography can be used to minimize the L2 loss as following, where L2 stands for L2 norm, H stands for ground truth homography and N stands for the total number of keypoints.

$${L}^{regression} = {\sum }_{i = 1}^{N} L 2 ( H ( \{ {x}_{frn} , {y}_{frn} \} ( i ) ) , \{ {x}_{frn \_ paired} , {y}_{frn \_ paired} \} ( i ) )$$

Like the refinement loss in the keypoint loss, refinement loss is used in detector loss as well which may cause the refined keypoints 822 to be better than the original keypoints 804, where L2 stands for L2 norm, H stands for ground truth homography, N stands for the total number of keypoints, {X_{fm}, Y_{fm}}(i) stands for refined keypoints 822 and {xₓ, yₓ}(i) stands for keypoints 804.

$${L}^{refinement \_ keypoint} = \frac{1}{N ( {\sum }_{i = 1}^{N} max ( 0 , ( \frac{\begin{matrix}L 2 ( H ( \{ {x}_{x} , {y}_{x} \} ( i ) ) , \\ \{ {x}_{x \_ paired} , {y}_{x \_ paired} \} ( i ) )\end{matrix}}{\begin{matrix}L 2 ( H ( \{ {x}_{frn} , {y}_{frn} \} ( i ) ) , \\ \{ {x}_{frn \_ paired} , {y}_{frn \_ paired} \} ( i ) )\end{matrix}} - 1 ) ) )}$$

In this way the final detector loss is as follows, where Φ² is a learnable parameter which acts as a regularization term

$${L}^{keypoint} = {L}^{regression} + {Φ}^{2} {L}^{refinement \_ keypoint}$$

And the total loss is:

$$L = {L}^{descriptor} + {L}^{keypoint}$$

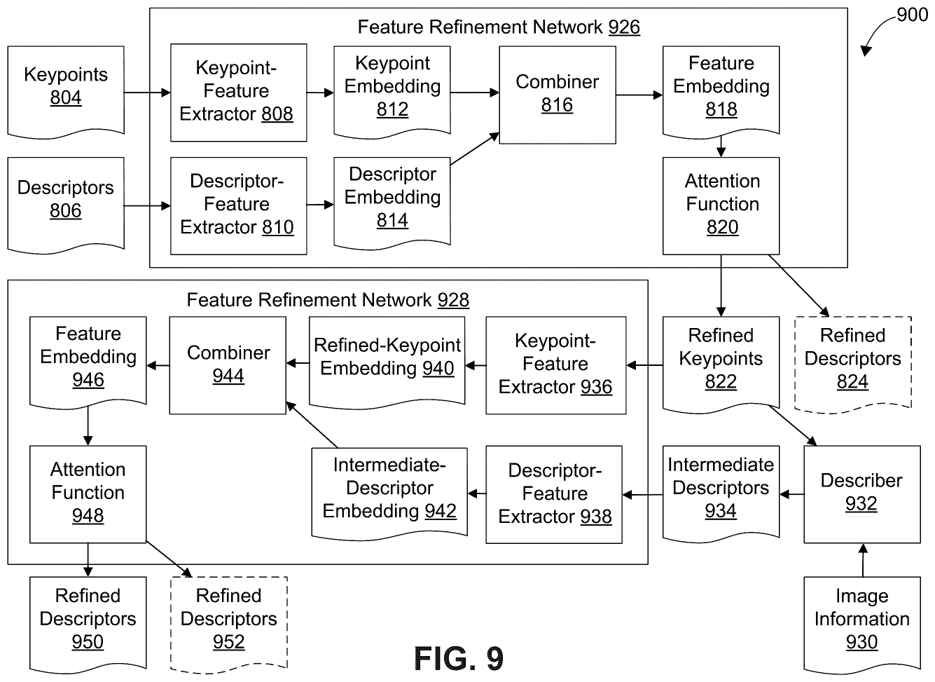

FIG. 9 is a block diagram of an example system 900 that may generate refined keypoints 822 and/or refined descriptors 950 based on keypoints 804 and descriptors 806, according to various aspects of the present disclosure. In general, system 900 may obtain keypoints 804 and descriptors 806, encode keypoints 804 to generate keypoint embedding 812, encode descriptors 806 to generate descriptor embedding 814, combine keypoint embedding 812 and descriptor embedding 814 to generate feature embedding 818, and apply attention function 820 to correlate feature embeddings of feature embedding 818 with other feature embeddings of feature embedding 818 to generate refined keypoints 822, encode refined keypoints 822 to generate refined-keypoint embedding 940, obtain intermediate descriptors 934, encode intermediate descriptors 934 to generate intermediate-descriptor embedding 942, combine refined-keypoint embedding 940 and intermediate-descriptor embedding 942 to generate feature embedding 946, and apply attention function 948 to correlate feature embeddings of feature embedding 946 with other feature embeddings of feature embedding 946 to generate refined descriptors 950.

System 900 includes feature refinement network 926 and feature refinement network 928. Together, feature refinement network 926 and feature refinement network 928 may be an example of feature refinement network 306 of FIG. 3.

Feature refinement network 926 may be, or may include, one or more machine-learning models trained to refine keypoints. Feature refinement network 926 may be the same as, may be substantially similar to, and/or may perform the same, or substantially the same, operations as feature refinement network 802 of FIG. 8. Feature refinement network 926 may include keypoint-feature extractor 808, descriptor-feature extractor 810, combiner 816, and attention function 820. In some aspects, like feature refinement network 802 of FIG. 8, feature refinement network 926 may generate refined keypoints 822 and refined descriptors 824. However, unlike system 800 of FIG. 8, system 900 may not output refined descriptors 824. As such, in some aspects, system 900 may discard refined descriptors 824. In other aspects, feature refinement network 926 may forego generating refined descriptors 824. As such, refined descriptors 824 is optional in system 900. The optional nature of refined descriptors 824 in system 900 is illustrated by refined descriptors 824 being illustrated using dashed lines.

Feature refinement network 928 may be, or may include, one or more machine-learning models trained to refine descriptors. Feature refinement network 928 may be the same as, may be substantially similar to, and/or may perform the same, or substantially the same, operations as feature refinement network 802 of FIG. 2. Feature refinement network 928 may include keypoint-feature extractor 936, descriptor-feature extractor 938, combiner 944, and attention function 948. Keypoint-feature extractor 936 may be the same as, may be substantially similar to, and/or may perform the same, or substantially the same, operations as keypoint-feature extractor 808. Descriptor-feature extractor 938 may be the same as, may be substantially similar to, and/or may perform the same, or substantially the same, operations as descriptor-feature extractor 810. Combiner 944 may be the same as, may be substantially similar to, and/or may perform the same, or substantially the same, operations as combiner 816. Attention function 948 may be the same as, may be substantially similar to, and/or may perform the same, or substantially the same, operations as attention function 820. In some aspects, like feature refinement network 802 of FIG. 8, feature refinement network 928 may generate refined keypoints refined descriptors 950 and refined descriptors 952 (which may be similar to refined keypoints 822 and refined descriptors 824 respectively). However, unlike system 800 of FIG. 8, system 900 may not output refined descriptors 952. As such, in some aspects, system 900 may discard refined descriptors 952. In other aspects, feature refinement network 928 may forego generating refined descriptors 952. As such, refined descriptors 952 is optional in system 900. The optional nature of refined descriptors 952 in system 900 is illustrated by refined descriptors 952 being illustrated using dashed lines.

System 900 may obtain keypoints 804 and descriptors 806 and use feature refinement network 926 to generate refined keypoints 822 based on keypoints 804 and descriptors 806. Feature refinement network 926 may generate refined keypoints 822 based on keypoints 804 and descriptors 806 in the same way that feature refinement network 802 of FIG. 8 generates refined keypoints 822 based on keypoints 804 and descriptors 806. Feature refinement network 926 may, or may not, generate refined descriptors 824.

System 900 may include describer 932. Describer 932 may generate intermediate descriptors 934 based on refined keypoints 822 and image information 930. Describer 932 may be substantially similar to describer 708 of FIG. 7. Image information 930 may be substantially similar to image information 710 of FIG. 7. Describer 932 may be, or may include, a machine-learning model (e.g., a neural network) trained to generate descriptors based on keypoints and image information. Describer 932 may implement FAST, SIFT, SURF, BRIEF, ORB, etc. to generate intermediate descriptors 934. Intermediate descriptors 934 may be, or may include, vectors of values describing respective ones of refined keypoints 822. For example, intermediate descriptors 934 may include values based on pixels in windows around refined keypoints 822. Image information 930 may include image information (e.g., values of pixels) based on refined keypoints 822. For example, image information 930 may include values of pixels in windows proximate to each of refined keypoints 822. Describer 932 may generate intermediate descriptors 934 based on image information 930.

Feature refinement network 928 may generate refined descriptors 950 based on refined keypoints 822 and intermediate descriptors 934. Feature refinement network 928 may generate refined descriptors 950 based on refined keypoints 822 and intermediate descriptors 934 in the same way that feature refinement network 802 of FIG. 8 generates refined descriptors 824 based on keypoints 804 and descriptors 806. Feature refinement network 928 may, or may not, generate refined descriptors 952.

System 900 may output refined keypoints 822 and refined descriptors 950. Keypoints 804 may be an example of keypoints 302 of FIG. 3. Descriptors 806 may be an example of descriptors 304 of FIG. 3. Image information 930 may be an example of image information 312 of FIG. 3. Refined keypoints 822 may be an example of refined keypoints 308 of FIG. 3. Refined descriptors 950 may be an example of refined descriptors 310 of FIG. 3.

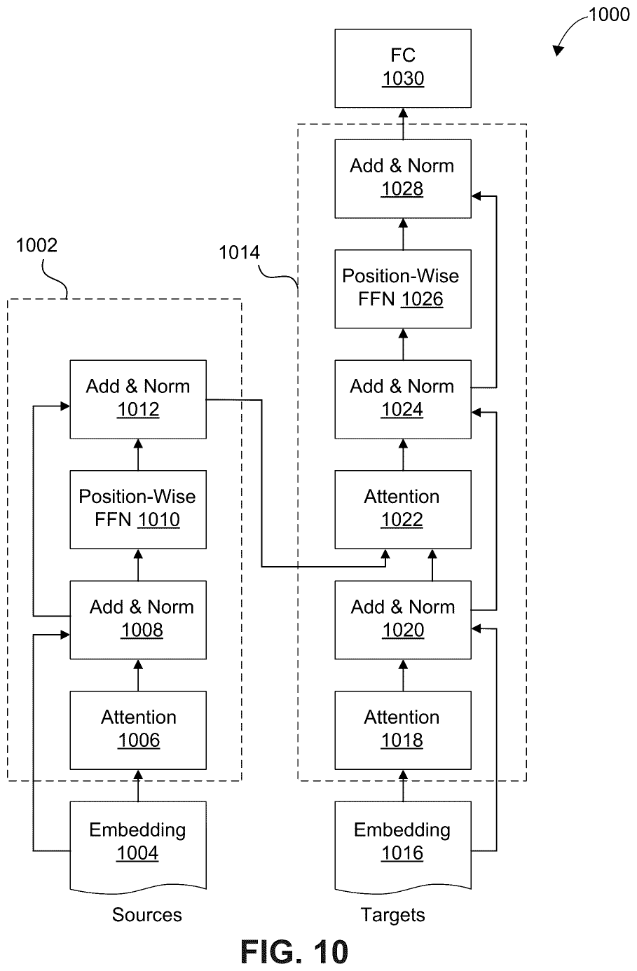

FIG. 10 is a block diagram of an example transformer 1000 that may be used to apply an attention function to feature embeddings to refine keypoints and/or descriptors, according to various aspects of the present disclosure. For example, transformer 1000 may calculate the mutual attention between the embedding space of each feature point (sources) with all the remaining feature points (targets). These embeddings may be the fused {keypoint+descriptor} embedding generated by the feature extractor network. For example, attention function 820 of FIG. 8 and FIG. 9 may implement transformer 1000 to generate refined keypoints 822 and/or refined descriptors 824 based on feature embedding 818. Additionally or alternatively, attention function 948 of FIG. 9 may implement transformer 1000 to generate refined descriptors 950 and refined descriptors 952 based on feature embedding 946.

The cross-attention helps capture both the global attention and the local attention of the feature embeddings for an image. The internal functioning of the cross-attention can be considered as an×n map, where n is the number of keypoints, where for each source feature point, there is an attention attached to all the remaining target feature points, indicating the importance of the target feature point towards the source feature point. In this manner, each feature point will have ‘n’ attentions, since there are total of ‘n’ such feature points it will be an attention matrix of size ‘n×n’.

The output of transformer 1000 is propagated to detection head and descriptor head. The output of detection head is mapped to (n×2), whereas the output of descriptor head is (n×p), where n is the number of keypoints, and p is the bit-width of the descriptor.

As an example, transformer 1000 may include encoder 1002 and decoder 1014. Encoder 1002 may obtain embedding 1004 (which may be an example of feature embedding 818 of FIG. 8). Encoder 1002 may apply multi-head attention to embedding 1004 at attention 1006. At add & norm 1008, encoder 1002 may combine and normalize the output of attention 1006 and embedding 1004. At position-wise feed-forward network (FFN) 1010, encoder 1002 may adjust the output of add & norm 1008 to be more suitable for use in decoder 1014. At add & norm 1012, encoder 1002 may combine and normalize the outputs of add & norm 1008 and position-wise FFN 1010. At attention 1018, decoder 1014 may apply multi-head attention to embedding 1016. At add & norm 1020, decoder 1014 may combine and normalize the output of attention 1018 and embedding 1016. At attention 1022, decoder 1014 may apply multi-head attention to the output of add & norm 1020. Attention 1022 may use an output of decoder 1002 (e.g., an output of add & norm 1012) as a query when processing the output of add & norm 1020. At add & norm 1024, decoder 1014 may combine and normalize the output of attention 1022 and add & norm 1020. At position-wise FFN 1026, decoder 1014 may adjust the output of add & norm 1024 to be more suitable to be output by decoder 1014. At add & norm 1028, decoder 1014 may combine and normalize the outputs of add & norm 1024 and position-wise FFN 1026. Fully connected layers (FC) 1030 may process the output of add & norm 1028.

In some aspects, transformer 1000 may include, or may implement, a neural architectural search (NAS) to optimize for the best neural network (NN) model meeting both accuracy and profiling numbers on DSP.

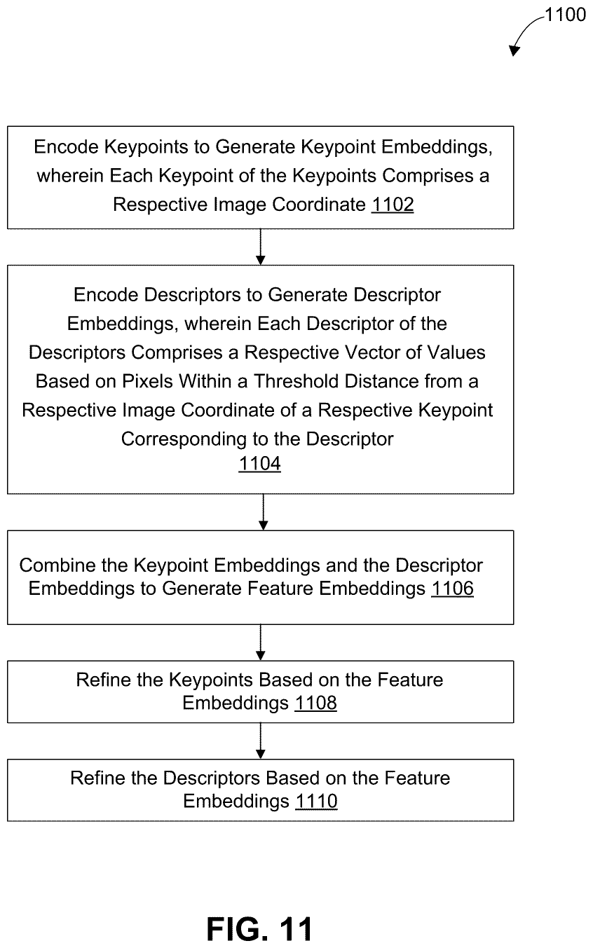

FIG. 11 is a flow diagram illustrating a process 1100 for refining keypoints and/or descriptors, in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1100. The one or more operations of process 1100 may be implemented as software components that are executed and run on one or more processors.

At block 1102, a computing device (or one or more components thereof) may encode keypoints to generate keypoint embeddings, wherein each keypoint of the keypoints comprises a respective image coordinate. For example, keypoint-feature extractor 808 of feature refinement network 802 of system 800 of FIG. 8 may encode keypoints 804 to generate keypoint embedding 812. Each of keypoints 804 may be, or may include, a respective image coordinate.

At block 1104, the computing device (or one or more components thereof) may encode descriptors to generate descriptor embeddings, wherein each descriptor of the descriptors comprises a respective vector of values based on pixels within a threshold distance from a respective image coordinate of a respective keypoint corresponding to the descriptor. For example, descriptor-feature extractor 810 of feature refinement network 802 of system 800 of FIG. 8 may encode descriptors 806 to generate descriptor embedding 814. Each of descriptors 806 may be, or may include, a respective vector of values based on pixels within a threshold distance from a respective image coordinate of a respective keypoint corresponding to the descriptor.

In some aspects, the keypoints may be encoded using a first multi-layer perceptron (MLP), and the descriptors may be encoded using a second MLP. For example, at block 1102, keypoints 804 may be encoded using keypoint-feature extractor 808, which may be a first MLP and descriptors 806 may be encoded using descriptor-feature extractor 810, which may be a second MLP.

At block 1106, the computing device (or one or more components thereof) may combine the keypoint embeddings and the descriptor embeddings to generate feature embeddings. For example, combiner 816 of feature refinement network 802 of system 800 of FIG. 8 may combine keypoint embedding 812 and descriptor embedding 814 to generate feature embedding 818.

In some aspects, to combine the keypoint embeddings and the descriptor embeddings, the computing device (or one or more components thereof) may concatenate the keypoint embeddings and the descriptor embeddings. For example, in some aspects, combiner 816 may concatenate keypoint embedding 812 and descriptor embedding 814 to generate feature embedding 818.

In some aspects, combine the keypoint embeddings and the descriptor embeddings, the computing device (or one or more components thereof) may apply an attention function to the keypoint embeddings and the descriptor embeddings to correlate the keypoint embeddings and the descriptor embeddings. For example, combiner 816 may apply an attention function to keypoint embedding 812 and descriptor embedding 814 to correlate keypoint embedding 812 and descriptor embedding 814 to generate feature embedding 818. In some aspects, the attention function may be, or may include, a cross-attention function.

At block 1108, the computing device (or one or more components thereof) may refine the keypoints based on the feature embeddings. For example, attention function 820 of feature refinement network 802 of system 800 of FIG. 8 may refine keypoints 804 based on feature embedding 818 to generate refined keypoints 822.

In some aspects, the refined keypoints may be, or may include, sub-pixel-resolution image coordinates.

At block 1110, the computing device (or one or more components thereof) may refine the descriptors based on the feature embeddings. For example, attention function 820 of feature refinement network 802 of system 800 of FIG. 8 may refine descriptors 806 based on feature embedding 818 to generate refined descriptors 824. As another example, feature refinement network 928 of system 900 of FIG. 9 may refine intermediate descriptors 934 based on feature embedding 946 to generate refined descriptors 950.

In some aspects, to refine the keypoints the computing device (or one or more components thereof) may apply an attention function to the feature embeddings to correlate each feature embedding of the feature embeddings with each other feature embedding of the feature embeddings to generate the refined keypoints and the refined descriptors. For example, attention function 820 of feature refinement network 802 of FIG. 8 may apply an attention function to feature embedding 818 to correlate each one of feature embedding 818 with each of the others of feature embedding 818 to generate refined keypoints 822 and refined descriptors 824. In some aspects, the attention function may be, or may include, a cross-attention function.

In some aspects, to refine the keypoints, the computing device (or one or more components thereof) may apply an attention function to the feature embeddings to correlate each feature embedding of the feature embeddings with each other feature embedding of the feature embeddings to generate the refined keypoints. For example, attention function 820 of feature refinement network 926 of system 900 of FIG. 9 may apply an attention function to feature embedding 818 to correlate each one of feature embedding 818 with each of the others of feature embedding 818 to generate refined keypoints 822. In some aspects, the attention function may be, or may include, a cross-attention function.

In some aspects, to refine the descriptors, the computing device (or one or more components thereof) may generate intermediate descriptors based on the refined keypoints and image information, wherein the image information is based on pixels proximate to image coordinates of refined keypoints; encode the refined keypoints to generate refined-keypoint embeddings; and encode the intermediate descriptors to generate intermediate-descriptor embeddings. For example, describer 932 of system 900 of FIG. 9 may generate intermediate descriptors 934 based on refined keypoints 822 and image information 930. Image information 930 may be based on pixels proximate to image coordinates of refined keypoints 822. Keypoint-feature extractor 936 of feature refinement network 928 of system 900 of FIG. 9 may encode refined keypoints 822 to generate refined-keypoint embeddings 940. Descriptor-feature extractor 938 of feature refinement network 928 of system 900 of FIG. 9 may encode intermediate descriptors 934 to generate intermediate-descriptor embeddings 942.

In some aspects, to refine the descriptors, the computing device (or one or more components thereof) may combine the refined-keypoint embeddings and the intermediate-descriptor embeddings to generate further feature embeddings. For example, combiner 944 of feature refinement network 928 of system 900 of FIG. 9 may combine refined-keypoint embedding 940 and intermediate-descriptor embedding 942 to generate feature embedding 946.

In some aspects, to combine the refined-keypoint embeddings and the intermediate-descriptor embeddings, the computing device (or one or more components thereof) may concatenate the refined-keypoint embeddings and the intermediate-descriptor embeddings. For example, combiner 944 may concatenate refined-keypoint embedding 940 and intermediate-descriptor embedding 942 to generate feature embedding 946.

In some aspects, to combine the refined-keypoint embeddings and the intermediate-descriptor embeddings, the computing device (or one or more components thereof) may apply an attention function to the refined-keypoint embeddings and the intermediate-descriptor embeddings to correlate the refined-keypoint embeddings and the intermediate-descriptor embeddings. For example, combiner 944 may apply an attention function to refined-keypoint embedding 940 and intermediate-descriptor embedding 942 to correlate refined-keypoint embedding 940 and intermediate-descriptor embedding 942. In some aspects, the attention function may be, or may include, a cross-attention function.

In some aspects, to refine the descriptors, the computing device (or one or more components thereof) may apply an attention function to the feature embeddings to correlate each feature embedding of the further feature embeddings with each other feature embedding of the further feature embeddings to generate the refined descriptors. For example, attention function 948 of feature refinement network 928 of system 900 of FIG. 9 may apply an attention function to feature embedding 946 to correlate each one of feature embedding 946 with each of the others of feature embedding 946 go generate refined descriptors 950. In some aspects, the attention function may be, or may include, a cross-attention function.

In some aspects, the computing device (or one or more components thereof) may track objects in images captured by a camera based on the refined keypoints and the refined descriptors; determine a pose of the camera based on the refined keypoints and the refined descriptors; and/or determine a location of the camera based on the refined keypoints and the refined descriptors. For example, a system or device implementing feature refinement network 306 may track objects in images captured by a camera based on refined keypoints 308 and/or refined descriptors 310 generated by feature refinement network 306. Further, the system or device may determine a pose and/or a location of the system or device based on refined keypoints 308 and/or refined descriptors 310.

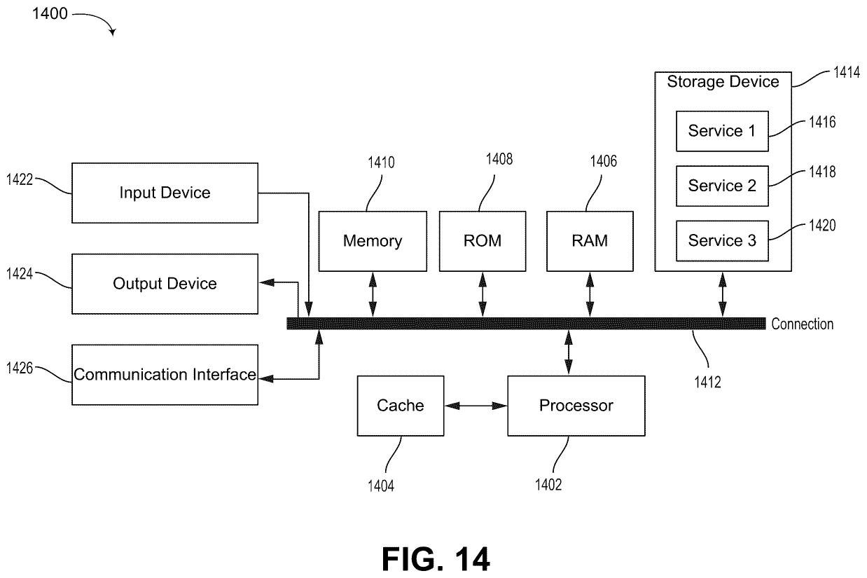

In some examples, as noted previously, the methods described herein (e.g., process 1100 of FIG. 11, and/or other methods described herein) can be performed, in whole or in part, by a computing device or apparatus. In one example, one or more of the methods can be performed by system 300 of FIG. 3, feature refinement network 306 of FIG. 3, system 800 of FIG. 8, feature refinement network 802 of FIG. 8, system 900 of FIG. 9, feature refinement network 926 of FIG. 9, feature refinement network 928 of FIG. 9, and/or by another system or device. In another example, one or more of the methods (e.g., process 1100 of FIG. 11, and/or other methods described herein) can be performed, in whole or in part, by the computing-device architecture 1400 shown in FIG. 14. For instance, a computing device with the computing-device architecture 1400 shown in FIG. 14 can include, or be included in, the components of system 300 of FIG. 3, feature refinement network 306 of FIG. 3, system 800 of FIG. 8, feature refinement network 802 of FIG. 8, system 900 of FIG. 9, feature refinement network 926 of FIG. 9, feature refinement network 928 of FIG. 9 and can implement the operations of process 1100, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

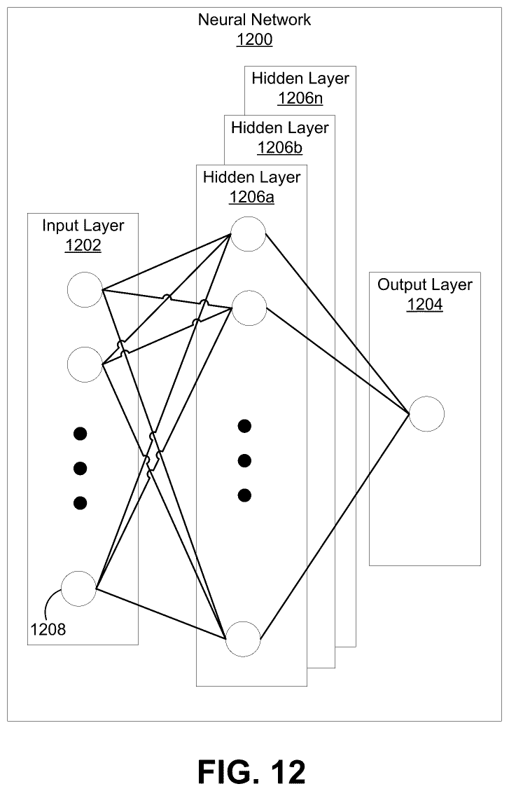

FIG. 12 is an illustrative example of a neural network 1200 (e.g., a deep-learning neural network) that can be used to implement machine-learning based feature identification, feature description, keypoint identification, keypoint description, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1200 may be an example of, or can implement, detector 704 of FIG. 7, describer 708 of FIG. 7, keypoint-feature extractor 808 of FIG. 8 and FIG. 9, descriptor-feature extractor 810 of FIG. 8 and FIG. 9, combiner 816 of FIG. 8 and FIG. 9, attention function 820 of FIG. 8 and FIG. 9, describer 932 of FIG. 9, keypoint-feature extractor 936 of FIG. 9, descriptor-feature extractor 938 of FIG. 9, combiner 944 of FIG. 9, attention function 948 of FIG. 9, encoder 1002 of FIG. 10, attention 1006 of FIG. 10, position-wise FFN 1010 of FIG. 10, attention 1018 of FIG. 10, attention 1022 of FIG. 10, and/or position-wise FFN 1026 of FIG. 10.

An input layer 1202 includes input data. In one illustrative example, input layer 1202 can include data representing image 702 of FIG. 7, keypoints 706 of FIG. 7, image information 710 of FIG. 7, keypoints 804 of FIG. 8 and FIG. 9, descriptors 806 of FIG. 8 and FIG. 9, keypoint embedding 812 of FIG. 8 and FIG. 9, descriptor embedding 814 of FIG. 8 and FIG. 9, feature embedding 818 of FIG. 8 and FIG. 9, image information 930 of FIG. 9, refined keypoints 822 of FIG. 9, intermediate descriptors 934 of FIG. 9, refined-keypoint embedding 940 of FIG. 9, intermediate-descriptor embedding 942 of FIG. 9, feature embedding 946 of FIG. 9, embedding 1004 of FIG. 10, and/or embedding 1016 of FIG. 10.

Neural network 1200 includes multiple hidden layers hidden layers 1206a, 1206b, through 1206n. The hidden layers 1206a, 1206b, through hidden layer 1206n include “n” number of hidden layers, where “n” is an integer greater than or equal to one. The number of hidden layers can be made to include as many layers as needed for the given application. Neural network 1200 further includes an output layer 1204 that provides an output resulting from the processing performed by the hidden layers 1206a, 1206b, through 1206n. In one illustrative example, output layer 1204 can provide keypoints 706 of FIG. 7, descriptors 712 of FIG. 7, keypoint embedding 812 of FIG. 8 and FIG. 9, descriptor embedding 814 of FIG. 8 and FIG. 9, feature embedding 818 of FIG. 8 and FIG. 9, refined keypoints 822 of FIG. 8 and FIG. 9, refined descriptors 824 of FIG. 8 and FIG. 9, intermediate descriptors 934 of FIG. 9, refined-keypoint embedding 940 of FIG. 9, intermediate-descriptor embedding 942 of FIG. 9, feature embedding 946 of FIG. 9, refined descriptors 950 of FIG. 9, and/or refined descriptors 952 of FIG. 9.

Neural network 1200 may be, or may include, a multi-layer neural network of interconnected nodes. Each node can represent a piece of information. Information associated with the nodes is shared among the different layers and each layer retains information as information is processed. In some cases, neural network 1200 can include a feed-forward network, in which case there are no feedback connections where outputs of the network are fed back into itself. In some cases, neural network 1200 can include a recurrent neural network, which can have loops that allow information to be carried across nodes while reading in input.

Information can be exchanged between nodes through node-to-node interconnections between the various layers. Nodes of input layer 1202 can activate a set of nodes in the first hidden layer 1206a. For example, as shown, each of the input nodes of input layer 1202 is connected to each of the nodes of the first hidden layer 1206a. The nodes of first hidden layer 1206a can transform the information of each input node by applying activation functions to the input node information. The information derived from the transformation can then be passed to and can activate the nodes of the next hidden layer 1206b, which can perform their own designated functions. Example functions include convolutional, up-sampling, data transformation, and/or any other suitable functions. The output of the hidden layer 1206b can then activate nodes of the next hidden layer, and so on. The output of the last hidden layer 1206n can activate one or more nodes of the output layer 1204, at which an output is provided. In some cases, while nodes (e.g., node 1208) in neural network 1200 are shown as having multiple output lines, a node has a single output and all lines shown as being output from a node represent the same output value.

In some cases, each node or interconnection between nodes can have a weight that is a set of parameters derived from the training of neural network 1200. Once neural network 1200 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1200 to be adaptive to inputs and able to learn as more and more data is processed.

Neural network 1200 may be pre-trained to process the features from the data in the input layer 1202 using the different hidden layers 1206a, 1206b, through 1206n in order to provide the output through the output layer 1204. In an example in which neural network 1200 is used to identify features in images, neural network 1200 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0010000000].

In some cases, neural network 1200 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 1200 is trained well enough so that the weights of the layers are accurately tuned.

For the example of identifying objects in images, the forward pass can include passing a training image through neural network 1200. The weights are initially randomized before neural network 1200 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1200, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1200 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Etotal=E′ (target-output) 2. The loss can be set to be equal to the value of Etotal.

The loss (or error) will be high for the first training images since the actual values will be much different than the predicted output. The goal of training is to minimize the amount of loss so that the predicted output is the same as the training label. Neural network 1200 can perform a backward pass by determining which inputs (weights) most contributed to the loss of the network and can adjust the weights so that the loss decreases and is eventually minimized. A derivative of the loss with respect to the weights (denoted as dLldW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

w=wᵢ−dL/ηd_{W},

where w denotes a weight, wᵢ denotes the initial weight, and η denotes a learning rate. The learning rate can be set to any suitable value, with a high learning rate including larger weight updates and a lower value indicating smaller weight updates.

Neural network 1200 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1200 can include any other deep network other than a CNN, such as an autoencoder, a deep belief nets (DBNs), a Recurrent Neural Networks (RNNs), among others.

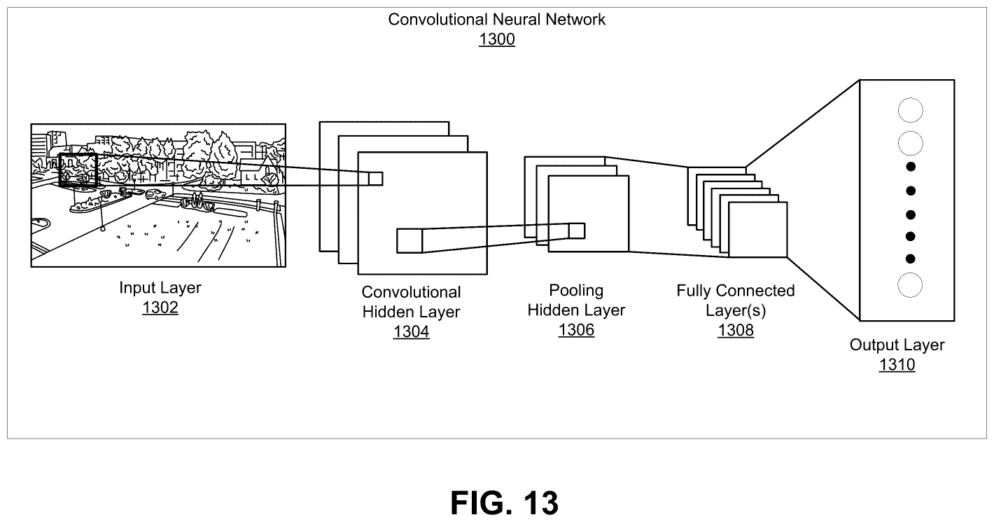

FIG. 13 is an illustrative example of a convolutional neural network (CNN) 1300. The input layer 1302 of the CNN 1300 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1304, an optional non-linear activation layer, a pooling hidden layer 1306, and fully connected layer 1308 (which fully connected layer 1308 can be hidden) to get an output at the output layer 1310. While only one of each hidden layer is shown in FIG. 13, one of ordinary skill will appreciate that multiple convolutional hidden layers, non-linear layers, pooling hidden layers, and/or fully connected layers can be included in the CNN 1300. As previously described, the output can indicate a single class of an object or can include a probability of classes that best describe the object in the image.

The first layer of the CNN 1300 can be the convolutional hidden layer 1304. The convolutional hidden layer 1304 can analyze image data of the input layer 1302. Each node of the convolutional hidden layer 1304 is connected to a region of nodes (pixels) of the input image called a receptive field. The convolutional hidden layer 1304 can be considered as one or more filters (each filter corresponding to a different activation or feature map), with each convolutional iteration of a filter being a node or neuron of the convolutional hidden layer 1304. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1304. Each connection between a node and a receptive field for that node learns a weight and, in some cases, an overall bias such that each node learns to analyze its particular local receptive field in the input image. Each node of the convolutional hidden layer 1304 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1304 is due to each node of the convolutional layer being applied to its corresponding receptive field. For example, a filter of the convolutional hidden layer 1304 can begin in the top-left corner of the input image array and can convolve around the input image. As noted above, each convolutional iteration of the filter can be considered a node or neuron of the convolutional hidden layer 1304. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1304. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1304.

The mapping from the input layer to the convolutional hidden layer 1304 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1304 can include several activation maps in order to identify multiple features in an image. The example shown in FIG. 13 includes three activation maps. Using three activation maps, the convolutional hidden layer 1304 can detect three different kinds of features, with each feature being detectable across the entire image.

In some examples, a non-linear hidden layer can be applied after the convolutional hidden layer 1304. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1300 without affecting the receptive fields of the convolutional hidden layer 1304.

The pooling hidden layer 1306 can be applied after the convolutional hidden layer 1304 (and after the non-linear hidden layer when used). The pooling hidden layer 1306 is used to simplify the information in the output from the convolutional hidden layer 1304. For example, the pooling hidden layer 1306 can take each activation map output from the convolutional hidden layer 1304 and generates a condensed activation map (or feature map) using a pooling function. Max-pooling is one example of a function performed by a pooling hidden layer. Other forms of pooling functions be used by the pooling hidden layer 1306, such as average pooling, L2-norm pooling, or other suitable pooling functions. A pooling function (e.g., a max-pooling filter, an L2-norm filter, or other suitable pooling filter) is applied to each activation map included in the convolutional hidden layer 1304. In the example shown in FIG. 13, three pooling filters are used for the three activation maps in the convolutional hidden layer 1304.

In some examples, max-pooling can be used by applying a max-pooling filter (e.g., having a size of 2×2) with a stride (e.g., equal to a dimension of the filter, such as a stride of 2) to an activation map output from the convolutional hidden layer 1304. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1304 having a dimension of 24×24 nodes, the output from the pooling hidden layer 1306 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1300.

The final layer of connections in the network is a fully-connected layer that connects every node from the pooling hidden layer 1306 to every one of the output nodes in the output layer 1310. Using the example above, the input layer includes 28×28 nodes encoding the pixel intensities of the input image, the convolutional hidden layer 1304 includes 3×24×24 hidden feature nodes based on application of a 5×5 local receptive field (for the filters) to three activation maps, and the pooling hidden layer 1306 includes a layer of 3×12×12 hidden feature nodes based on application of max-pooling filter to 2×2 regions across each of the three feature maps. Extending this example, the output layer 1310 can include ten output nodes. In such an example, every node of the 3×12×12 pooling hidden layer 1306 is connected to every node of the output layer 1310.

The fully connected layer 1308 can obtain the output of the previous pooling hidden layer 1306 (which should represent the activation maps of high-level features) and determines the features that most correlate to a particular class. For example, the fully connected layer 1308 can determine the high-level features that most strongly correlate to a particular class and can include weights (nodes) for the high-level features. A product can be computed between the weights of the fully connected layer 1308 and the pooling hidden layer 1306 to obtain probabilities for the different classes. For example, if the CNN 1300 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1310 can include an M-dimensional vector (in the prior example, M=10). M indicates the number of classes that the CNN 1300 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 000 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 14 illustrates an example computing-device architecture 1400 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1400 may include, implement, or be included in any or all of system 300 of FIG. 3, feature refinement network 306 of FIG. 3, system 800 of FIG. 8, feature refinement network 802 of FIG. 8, system 900 of FIG. 9, feature refinement network 926 of FIG. 9, feature refinement network 928 of FIG. 9, transformer 1000 of FIG. 10, encoder 1002 of FIG. 10, and/or embedding 1016 of FIG. 10. Additionally or alternatively, computing-device architecture 1400 may be configured to perform process 1100, and/or other process described herein.

The components of computing-device architecture 1400 are shown in electrical communication with each other using connection 1412, such as a bus. The example computing-device architecture 1400 includes a processing unit (CPU or processor) 1402 and computing device connection 1412 that couples various computing device components including computing device memory 1410, such as read only memory (ROM) 1408 and random-access memory (RAM) 1406, to processor 1402.

Computing-device architecture 1400 can include a cache of high-speed memory connected directly with, in close proximity to, or integrated as part of processor 1402. Computing-device architecture 1400 can copy data from memory 1410 and/or the storage device 1414 to cache 1404 for quick access by processor 1402. In this way, the cache can provide a performance boost that avoids processor 1402 delays while waiting for data. These and other modules can control or be configured to control processor 1402 to perform various actions. Other computing device memory 1410 may be available for use as well. Memory 1410 can include multiple different types of memory with different performance characteristics. Processor 1402 can include any general-purpose processor and a hardware or software service, such as service 1 1416, service 2 1418, and service 3 1420 stored in storage device 1414, configured to control processor 1402 as well as a special-purpose processor where software instructions are incorporated into the processor design. Processor 1402 may be a self-contained system, containing multiple cores or processors, a bus, memory controller, cache, etc. A multi-core processor may be symmetric or asymmetric.

To enable user interaction with the computing-device architecture 1400, input device 1422 can represent any number of input mechanisms, such as a microphone for speech, a touch-sensitive screen for gesture or graphical input, keyboard, mouse, motion input, speech and so forth. Output device 1424 can also be one or more of a number of output mechanisms known to those of skill in the art, such as a display, projector, television, speaker device, etc. In some instances, multimodal computing devices can enable a user to provide multiple types of input to communicate with computing-device architecture 1400. Communication interface 1426 can generally govern and manage the user input and computing device output. There is no restriction on operating on any particular hardware arrangement and therefore the basic features here may easily be substituted for improved hardware or firmware arrangements as they are developed.

Storage device 1414 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1406, read only memory (ROM) 1408, and hybrids thereof. Storage device 1414 can include services 1416, 1418, and 1420 for controlling processor 1402. Other hardware or software modules are contemplated. Storage device 1414 can be connected to the computing device connection 1412. In one aspect, a hardware module that performs a particular function can include the software component stored in a computer-readable medium in connection with the necessary hardware components, such as processor 1402, connection 1412, output device 1424, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), Flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for refining image keypoints, the apparatus comprising: at least one memory; and at least one processor coupled to the at least one memory and configured to: encode keypoints to generate keypoint embeddings, wherein each keypoint of the keypoints comprises a respective image coordinate; encode descriptors to generate descriptor embeddings, wherein each descriptor of the descriptors comprises a respective vector of values based on pixels within a threshold distance from a respective image coordinate of a respective keypoint corresponding to the descriptor; combine the keypoint embeddings and the descriptor embeddings to generate feature embeddings; refine the keypoints based on the feature embeddings; and refine the descriptors based on the feature embeddings.
Aspect 2. The apparatus of aspect 1, wherein the keypoints are encoded using a first multi-layer perceptron (MLP), and wherein the descriptors are encoded using a second MLP.
Aspect 3. The apparatus of any one of aspects 1 or 2, wherein, to combine the keypoint embeddings and the descriptor embeddings, the at least one processor is configured to concatenate the keypoint embeddings and the descriptor embeddings.
Aspect 4. The apparatus of any one of aspects 1 to 3, wherein, to combine the keypoint embeddings and the descriptor embeddings, the at least one processor is configured to apply an attention function to the keypoint embeddings and the descriptor embeddings to correlate the keypoint embeddings and the descriptor embeddings.
Aspect 5. The apparatus of aspect 4, wherein the attention function comprises a cross-attention function.
Aspect 6. The apparatus of any one of aspects 1 to 5, wherein, to refine the keypoints the at least one processor is configured to apply an attention function to the feature embeddings to correlate each feature embedding of the feature embeddings with each other feature embedding of the feature embeddings to generate the refined keypoints and the refined descriptors.
Aspect 7. The apparatus of aspect 6, wherein the attention function comprises a cross-attention function.
Aspect 8. The apparatus of any one of aspects 1 to 7, wherein, to refine the keypoints, the at least one processor is configured to apply an attention function to the feature embeddings to correlate each feature embedding of the feature embeddings with each other feature embedding of the feature embeddings to generate the refined keypoints.
Aspect 9. The apparatus of aspect 8, wherein the attention function comprises a cross-attention function.
Aspect 10. The apparatus of any one of aspects 8 or 9, wherein, to refine the descriptors, the at least one processor is configured to: generate intermediate descriptors based on the refined keypoints and image information, wherein the image information is based on pixels proximate to image coordinates of refined keypoints; encode the refined keypoints to generate refined-keypoint embeddings; and encode the intermediate descriptors to generate intermediate-descriptor embeddings.
Aspect 11. The apparatus of aspect 10, wherein, to refine the descriptors, the at least one processor is configured to combine the refined-keypoint embeddings and the intermediate-descriptor embeddings to generate further feature embeddings.
Aspect 12. The apparatus of aspect 11, wherein, to combine the refined-keypoint embeddings and the intermediate-descriptor embeddings, the at least one processor is configured to concatenate the refined-keypoint embeddings and the intermediate-descriptor embeddings.
Aspect 13. The apparatus of any one of aspects 11 or 12, wherein, to combine the refined-keypoint embeddings and the intermediate-descriptor embeddings, the at least one processor is configured to apply an attention function to the refined-keypoint embeddings and the intermediate-descriptor embeddings to correlate the refined-keypoint embeddings and the intermediate-descriptor embeddings.
Aspect 14. The apparatus of aspect 13, wherein the attention function comprises a cross-attention function.
Aspect 15. The apparatus of any one of aspects 11 to 14, wherein, to refine the descriptors, the at least one processor is configured to apply an attention function to the feature embeddings to correlate each feature embedding of the further feature embeddings with each other feature embedding of the further feature embeddings to generate the refined descriptors.
Aspect 16. The apparatus of aspect 15, wherein the attention function comprises a cross-attention function.
Aspect 17. The apparatus of any one of aspects 1 to 16, wherein the refined keypoints comprise sub-pixel-resolution image coordinates.
Aspect 18. The apparatus of any one of aspects 1 to 17, the at least one processor is further configured to at least one of: track objects in images captured by a camera based on the refined keypoints and the refined descriptors; determine a pose of the camera based on the refined keypoints and the refined descriptors; or determine a location of the camera based on the refined keypoints and the refined descriptors.
Aspect 19. A method for refining image keypoints, the method comprising: encoding keypoints to generate keypoint embeddings, wherein each keypoint of the keypoints comprises a respective image coordinate; encoding descriptors to generate descriptor embeddings, wherein each descriptor of the descriptors comprises a respective vector of values based on pixels within a threshold distance from a respective image coordinate of a respective keypoint corresponding to the descriptor; combining the keypoint embeddings and the descriptor embeddings to generate feature embeddings; refining the keypoints based on the feature embeddings; and refining the descriptors based on the feature embeddings.
Aspect 20. The method of aspect 19, wherein the keypoints are encoded using a first multi-layer perceptron (MLP), and wherein the descriptors are encoded using a second MLP.
Aspect 21. The method of any one of aspects 19 or 20, wherein combining the keypoint embeddings and the descriptor embeddings comprises concatenating the keypoint embeddings and the descriptor embeddings.
Aspect 22. The method of any one of aspects 19 to 21, wherein combining the keypoint embeddings and the descriptor embeddings comprises applying an attention function to the keypoint embeddings and the descriptor embeddings to correlate the keypoint embeddings and the descriptor embeddings.
Aspect 23. The method of aspect 22, wherein the attention function comprises a cross-attention function.
Aspect 24. The method of any one of aspects 19 to 23, wherein refining the keypoints further comprises applying an attention function to the feature embeddings to correlate each feature embedding of the feature embeddings with each other feature embedding of the feature embeddings to generate the refined keypoints and the refined descriptors.
Aspect 25. The method of aspect 24, wherein the attention function comprises a cross-attention function.
Aspect 26. The method of any one of aspects 19 to 25, wherein refining the keypoints further comprises applying an attention function to the feature embeddings to correlate each feature embedding of the feature embeddings with each other feature embedding of the feature embeddings to generate the refined keypoints.
Aspect 27. The method of aspect 26, wherein the attention function comprises a cross-attention function.
Aspect 28. The method of any one of aspects 26 or 27, wherein refining the descriptors further comprises: generating intermediate descriptors based on the refined keypoints and image information, wherein the image information is based on pixels proximate to image coordinates of refined keypoints; encoding the refined keypoints to generate refined-keypoint embeddings; and encoding the intermediate descriptors to generate intermediate-descriptor embeddings.
Aspect 29. The method of aspect 28, wherein refining the descriptors further comprises combining the refined-keypoint embeddings and the intermediate-descriptor embeddings to generate further feature embeddings.
Aspect 30. The method of aspect 29, wherein combining the refined-keypoint embeddings and the intermediate-descriptor embeddings comprises concatenating the refined-keypoint embeddings and the intermediate-descriptor embeddings.
Aspect 31. The method of any one of aspects 29 or 30, wherein combining the refined-keypoint embeddings and the intermediate-descriptor embeddings comprises applying an attention function to the refined-keypoint embeddings and the intermediate-descriptor embeddings to correlate the refined-keypoint embeddings and the intermediate-descriptor embeddings.
Aspect 32. The method of aspect 31, wherein the attention function comprises a cross-attention function.
Aspect 33. The method of any one of aspects 29 to 32, wherein refining the descriptors further comprises applying an attention function to the feature embeddings to correlate each feature embedding of the further feature embeddings with each other feature embedding of the further feature embeddings to generate the refined descriptors.
Aspect 34. The method of aspect 33, wherein the attention function comprises a cross-attention function.
Aspect 35. The method of any one of aspects 19 to 34, wherein the refined keypoints comprise sub-pixel-resolution image coordinates.
Aspect 36. The method of any one of aspects 19 to 34, further comprising at least one of: tracking objects in images captured by a camera based on the refined keypoints and the refined descriptors; determining a pose of the camera based on the refined keypoints and the refined descriptors; or determining a location of the camera based on the refined keypoints and the refined descriptors.
Aspect 37. A non-transitory computer-readable medium having stored thereon instructions that, when executed by one or more processors, cause the one or more processors to perform operations according to any of Aspects 19 to 36.
Aspect 38. An apparatus including one or more means for performing operations according to any of Aspects 19 to 36.

What is claimed is:

1. An apparatus for refining image keypoints, the apparatus comprising:
at least one memory; and
at least one processor coupled to the at least one memory and configured to:
encode keypoints to generate keypoint embeddings, wherein each keypoint of the keypoints comprises a respective image coordinate;
encode descriptors to generate descriptor embeddings, wherein each descriptor of the descriptors comprises a respective vector of values based on pixels within a threshold distance from a respective image coordinate of a respective keypoint corresponding to the descriptor;
combine the keypoint embeddings and the descriptor embeddings to generate feature embeddings;
refine the keypoints based on the feature embeddings; and
refine the descriptors based on the feature embeddings.

2. The apparatus of claim 1, wherein the keypoints are encoded using a first multi-layer perceptron (MLP), and wherein the descriptors are encoded using a second MLP.

3. The apparatus of claim 1, wherein, to combine the keypoint embeddings and the descriptor embeddings, the at least one processor is configured to concatenate the keypoint embeddings and the descriptor embeddings.

4. The apparatus of claim 1, wherein, to combine the keypoint embeddings and the descriptor embeddings, the at least one processor is configured to apply an attention function to the keypoint embeddings and the descriptor embeddings to correlate the keypoint embeddings and the descriptor embeddings.

5. The apparatus of claim 1, wherein, to refine the keypoints the at least one processor is configured to apply an attention function to the feature embeddings to correlate each feature embedding of the feature embeddings with each other feature embedding of the feature embeddings to generate the refined keypoints and the refined descriptors.

6. The apparatus of claim 1, wherein, to refine the keypoints, the at least one processor is configured to apply an attention function to the feature embeddings to correlate each feature embedding of the feature embeddings with each other feature embedding of the feature embeddings to generate the refined keypoints.

7. The apparatus of claim 6, wherein, to refine the descriptors, the at least one processor is configured to:
generate intermediate descriptors based on the refined keypoints and image information, wherein the image information is based on pixels proximate to image coordinates of refined keypoints;
encode the refined keypoints to generate refined-keypoint embeddings; and
encode the intermediate descriptors to generate intermediate-descriptor embeddings.

8. The apparatus of claim 7, wherein, to refine the descriptors, the at least one processor is configured to combine the refined-keypoint embeddings and the intermediate-descriptor embeddings to generate further feature embeddings.

9. The apparatus of claim 8, wherein, to combine the refined-keypoint embeddings and the intermediate-descriptor embeddings, the at least one processor is configured to concatenate the refined-keypoint embeddings and the intermediate-descriptor embeddings.

10. The apparatus of claim 8, wherein, to combine the refined-keypoint embeddings and the intermediate-descriptor embeddings, the at least one processor is configured to apply an attention function to the refined-keypoint embeddings and the intermediate-descriptor embeddings to correlate the refined-keypoint embeddings and the intermediate-descriptor embeddings.

11. The apparatus of claim 8, wherein, to refine the descriptors, the at least one processor is configured to apply an attention function to the feature embeddings to correlate each feature embedding of the further feature embeddings with each other feature embedding of the further feature embeddings to generate the refined descriptors.

12. The apparatus of claim 1, wherein the refined keypoints comprise sub-pixel-resolution image coordinates.

13. The apparatus of claim 1, the at least one processor is further configured to at least one of:
track objects in images captured by a camera based on the refined keypoints and the refined descriptors;
determine a pose of the camera based on the refined keypoints and the refined descriptors;
or
determine a location of the camera based on the refined keypoints and the refined descriptors.

14. A method for refining image keypoints, the method comprising:
encoding keypoints to generate keypoint embeddings, wherein each keypoint of the keypoints comprises a respective image coordinate;
encoding descriptors to generate descriptor embeddings, wherein each descriptor of the descriptors comprises a respective vector of values based on pixels within a threshold distance from a respective image coordinate of a respective keypoint corresponding to the descriptor;
combining the keypoint embeddings and the descriptor embeddings to generate feature embeddings;
refining the keypoints based on the feature embeddings; and
refining the descriptors based on the feature embeddings.

15. The method of claim 14, wherein the keypoints are encoded using a first multi-layer perceptron (MLP), and wherein the descriptors are encoded using a second MLP.

16. The method of claim 14, wherein combining the keypoint embeddings and the descriptor embeddings comprises concatenating the keypoint embeddings and the descriptor embeddings.

17. The method of claim 14, wherein combining the keypoint embeddings and the descriptor embeddings comprises applying an attention function to the keypoint embeddings and the descriptor embeddings to correlate the keypoint embeddings and the descriptor embeddings.

18. The method of claim 14, wherein refining the keypoints further comprises applying an attention function to the feature embeddings to correlate each feature embedding of the feature embeddings with each other feature embedding of the feature embeddings to generate the refined keypoints and the refined descriptors.

19. The method of claim 14, wherein refining the keypoints further comprises applying an attention function to the feature embeddings to correlate each feature embedding of the feature embeddings with each other feature embedding of the feature embeddings to generate the refined keypoints.

20. The method of claim 19, wherein refining the descriptors further comprises:
generating intermediate descriptors based on the refined keypoints and image information, wherein the image information is based on pixels proximate to image coordinates of refined keypoints;
encoding the refined keypoints to generate refined-keypoint embeddings; and
encoding the intermediate descriptors to generate intermediate-descriptor embeddings.
